(19) United States
(12) Patent Application Publication
(10) Pub. No.: US 2025/0103869 A1
(43) Pub. Date: Mar. 27, 2025

(54) COMPRESSION OF NEURAL NETWORKS WITH ORTHOGONAL MATRICES

(71) Applicant: Microsoft Technology Licensing, LLC, Redmond, WA (US)

(72) Inventors: Marcelo GENNARI DO NASCIMENTO, Cambridge (GB); James John HENSMAN, Cambridge (GB); Saleh ASHKBOOS, Cambridge (GB); Maximilian Louis CROCI, Cambridge (GB)

(21) Appl. No.: 18/536,154

(22) Filed: Dec. 11, 2023

Related U.S. Application Data
(60) Provisional application No. 63/584,481, filed on Sep. 21, 2023.

(51) Int. Cl. G06N 3/0495; G06N 3/082

(52) U.S. Cl. CPC G06N 3/0495; G06N 3/082

(57) ABSTRACT

Embodiment herein relate to a neural network compression technique, in which a weight matrix within the neural network is transformed via matrix multiplication with an orthogonal matrix. The orthogonal matrix is derived from a calibration dataset (which is generally chosen to be broadly representative of expected runtime input data), and the transformation is such that a resulting modified weight matrix has components ordered by relative significance. The modified weight matrix is incorporated in a compressed neural network with fewer weights. By removing one or more components of lower significance, the size of the neural network (and, therefore, its storage and execution overhead) are reduced, whilst still maintaining an acceptable level of performance.

### CROSS-REFERENCE TO RELATED APPLICATION

This application claims priority to U.S. Provisional Patent Application No. 63/584,481, entitled “COMPRESSION BY ROTATING THE EMBEDDING SPACE USING ORTHOGONAL MATRICES,” filed on Sep. 21, 2023, the disclosure of which is incorporated herein by reference in its entirety.

### TECHNICAL FIELD

The present disclosure relates to methods, systems and computer programs for compressing neural networks, as well as to compressed neural networks obtained using such techniques and applications thereof.

### BACKGROUND

Neural networks can be used to output information based on input data. Neural networks have been applied in many fields of technology, such as image processing, video processing, audio processing and other forms of signal processing, cybersecurity, natural language processing. Generative neural networks have been used, among other things, to generate synthetic images or video sequence, synthetic audio (e.g., music), text etc. As neural networks become more complex, the amount of processing required to compute an output from an input of the neural network is increased. Further, the amount of memory required to store the neural network is increased. A trained neural network includes weights that are learned in a structured training process on a training set (or sets). Neural networks have always required significant computational resources to train, particularly on large training sets. However, post-training, significant storage resources are required to store a trained neural network, and significant computational resources are required to execute such a network on an input at time. Such considerations are increasingly significant with the emergence of ‘large’ neural networks (such as transformers with billions of weights), and with the increasing range of scenarios in which trained neural networks are deployed to systems with limited processing and storage resources (such as wearable devices, mobile devices, Internet-of-Things (IoT) devices, autonomous vehicles, drones and other mobile robots etc.).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Embodiment herein relate to a neural network compression technique, in which a weight matrix within the neural network is transformed via matrix multiplication with an orthogonal matrix. The orthogonal matrix is derived from a calibration dataset (which is generally chosen to be broadly representative of expected runtime input data), and the transformation is such that a resulting modified weight matrix has components ordered by relative significance. The modified weight matrix is incorporated in a compressed neural network with fewer weights. By removing one or more components of lower significance, the size of the compressed neural network (and, therefore, its storage and execution overhead) are reduced, whilst still maintaining an acceptable level of performance.

### BRIEF DESCRIPTION OF FIGURES

Particular embodiments will now be described, by way of example only, with reference to the following schematic figures, in which:

FIG. 1 shows a flow chart of a neural network method.

FIG. 2 shows a flow chart of a LayerNorm normalisation method.

FIG. 3 shows a flow chart of a neural network method with self-attention and multi-layer perceptron (MLP) structures.

FIG. 4 shows part of a neural network method with an RMSNorm normalizer method.

FIG. 5 shows a flow chart of a neural network method with self-attention and MLP structures.

FIG. 6 shows a block diagram of the steps in a method to convert a LayerNorm normalizer block to a StandardNorm normalizer block.

FIG. 7 shows a block diagram of the steps in a method of applying orthogonal matrices to a neural network.

FIG. 8 shows a flow chart of part of a neural network-based method with ortho-linear layers.

FIG. 9 shows a flow chart of a neural network-based method with self-attention and MLP structures.

FIG. 10 shows a flowchart of a neural network method with generative pre-trained transformer (GPT) blocks.

FIG. 11 shows a flowchart of a neural network method with GPT blocks.

FIG. 12 schematically shows a non-limiting example of a computing system.

### DETAILED DESCRIPTION

As noted, so-called ‘large’ neural networks (such as transformers having billions of learned weights or more) require not only significant resources to train, but also significant computational resources to store once trained (as each weight needs to be stored electronically), and significant processing resources to execute at runtime (as each additional weight increases the number of computations that need to be performed). Even smaller neural networks, with fewer weights, have a storage and runtime execution overhead which can be significant in many contexts. Challenges arise, for example, when neural networks of any size are to be stored and executed in computing-resource-limited systems (such as mobile devices, wearable devices, IoT or ‘edge’ devices within limited storage and processing resources). For battery-powered devices, reduced power consumption is an important aim, and one way to decrease power consumption is to reduce the computational overhead of a neural network stored and executed on such a device.

Network compressions techniques are described herein which are able to significantly increase the efficiency of neural network computations with, at worst, a minimal reduction in performance. Given a trained neural network to be deployed, a system to “shrink” the neural network is provided, by slicing off parts of the weight matrices of the neural network. The “shrinking” makes the computational requirements to deploy the neural network significantly lower.

The present neural network compression techniques reduce the amount of storage required to store the compressed neural network in memory, in addition to reducing an amount of processing required in order to a neural network to provide an output form an input. Examples described herein describe a method of neural network compression that minimises losses in performance arising from the compression (which could be measured for example, in perplexity accuracy or precision).

The aforementioned compression techniques are motivated by a desire to reduce the amount of storage resources and computational resources consumed by a trained neural network whilst maintaining an acceptable level of performance. In example embodiments, this is achieved by modifying a weight matrix within a neural network based on a calibration dataset, resulting in a modified weight matrix comprising multiple components ordered by relative significance. This, in turn, enables one or more components of lower significance to be removed, yielding a reduction in the size of the network with reduced impact on performance (in comparison to simply reducing the size of the original weight matrix). A compressed neural network generated in this manner yields an improvement in a computer system configured to store and execute the compressed neural network, as it able to achieve a given level of performance whilst consuming fewer storage resources and fewer processing recourses at runtime than the original (uncompressed) neural network.

Some examples described herein provide a method of determining a form for processing blocks of a neural network. This form allows the blocks to be truncated with minimal losses in performance.

Neural networks may interface with the real-world in term of both its inputs and its outputs/effects. For example, multiple candidate actions may be evaluated via causal inference, in order to select an action (or subset of actions) of highest estimated effectiveness, and perform the selected action on a physical system(s) resulting in a tangible, real-world outcome. Input may take the form of measurable physical quantities such as energy, material properties, processing, usage of memory/storage resources in a computer system, therapeutic effect etc. Such quantities may, for example, be measured directly using a sensor system or estimated from measurements of another physical quantity or quantities.

Examples described herein can achieve a given level of perplexity with reduced memory and processing requirements. Some examples also reduce an amount of data passing between blocks of a neural network.

Some examples described herein use a calibration dataset to determine orthogonal matrices at outputs of processing blocks of a neural network. The calibration dataset may be representative of datasets for which the neural network is intended to be used.

A neural network may comprise one or more processing blocks. Each processing block may comprise one or more weight matrices. Normalizer blocks may be positioned in between each processing block. Rather than the normalizer block comprising a LayerNorm operation, some of the LayerNorm operations may be absorbed into a previous processing block and some of the LayerNorm operations may be absorbed into the subsequent processing block. This allows a StandardNorm operation to be used in between each processing block rather than a LayerNorm. In other examples, neural networks using root mean square (RMS) norm can be similarly converted.

When the neural network is in a standardized form as described above, the orthogonal matrices for each normalizer block can be determined. For each normalizer block, the orthogonal matrix may be applied to the subsequent processing block and the transpose of the orthogonal block can be applied to the previous processing block. This results in a modified weight matrix in each processing block comprising multiple components ordered by relative significance. At least one component of relatively low significance can then be removed from at least one modified weight matrix, resulting in at least one truncated weight matrix. This may comprise removing the least important X % of components from the modified weight matrix, based on the order of relative significance in the weight matrix. This provides a compressed neural network. By removing components that are relatively low importance, reduction in performance of the neural network is minimized. In some examples the method is applied to compress a neural network that is already trained.

The present approach has numerous practical applications, including the processing and generation of images, videos, text, audio, etc., from one or more physical devices such as a camera, microphone, sensor, and the like. Technical applications may comprise technical applications of attention-based neural networks including image generation, audio signal processing, audio or music generation etc. Another application is cybersecurity, where cybersecurity knowledge may be captured in a structured model and used, e.g., to implement cyberthreat detection and/or cyberthreat remediation by causing or instructing a device to take remediating or mitigating actions.

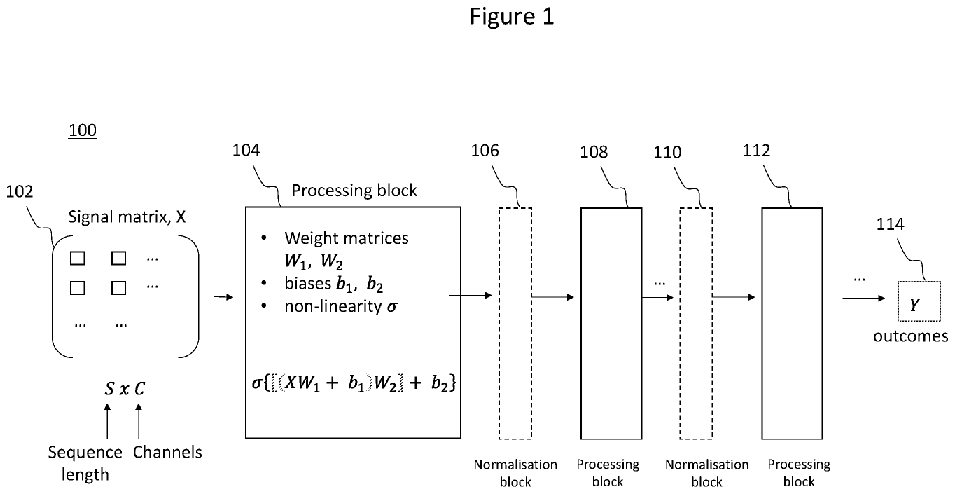

FIG. 1 shows a neural network, which is an algorithm that computes predicted outcomes 114, Y, from some signals 102, X. The network is defined by a series of weight-matrices Wᵢ and nonlinearities σᵢ. In the context of language modelling, X is a matrix whose rows correspond to elements of a sequence of words, characters or tokens, and whose columns are referred to as channels. In other applications, the elements of X could for example represent image pixel or image regions, segments of audio data, sensor datapoints etc. The dimensions of X are denoted as S (sequence length) and C (channels). The weight matrices and nonlinearities are arranged into blocks, containing two weight matrices and a single nonlinearity. The dimensions of the weight matrices in the block are arranged such that the input and output channels of the block are equal to C. Note that ‘X’ is used to represent both the original input to the network, as well as transformations versions of the original input computed within the network.

FIG. 1 further shows the matrix operations performed at a processing block 104 as defined by Algorithm 1. The processing block is defined by the weight matrices W₁ and W₂, the biases b₁ and b₂, and the non-linearity σ. The processing block receives as input the signal matrix 102, X. Matrix X is multiplied by W₁, and bias b₁ is added to the result XW₁. The result, XW₁+b₁, is then multiplied by the second weight matrix W₂, and bias b₂ is added to the result, giving [(XW₁+b₁) W₂]+b₂. The non-linear operation σ is then applied to this result, giving σ{[(XW₁+b₁) W₂]+b₂}. The nonlinear operation sigma may operate element-wise, or across elements: this incorporates the attention mechanism and multi-layer-perceptron algorithms. Computation blocks may operate on multiple signals simultaneously (a so-called batch operation).

Algorithm 1: Processing block

Input: signal matrix X, the weight matrices W₁ and W₂, the biases b₁ and
b₂, and the non-linearity σ
Output: matrix multiplication σ{[(XW₁ + b₁)W₂] + b₂}

FIG. 1 further shows the neural network consisting of a series of processing blocks 104, 108, 112, arranged sequentially, and interspersed with normalizer blocks 106, 110 which perform normalization operations. The normalizer operation may be one of LayerNorm, RMSNorm, LINorm or other.

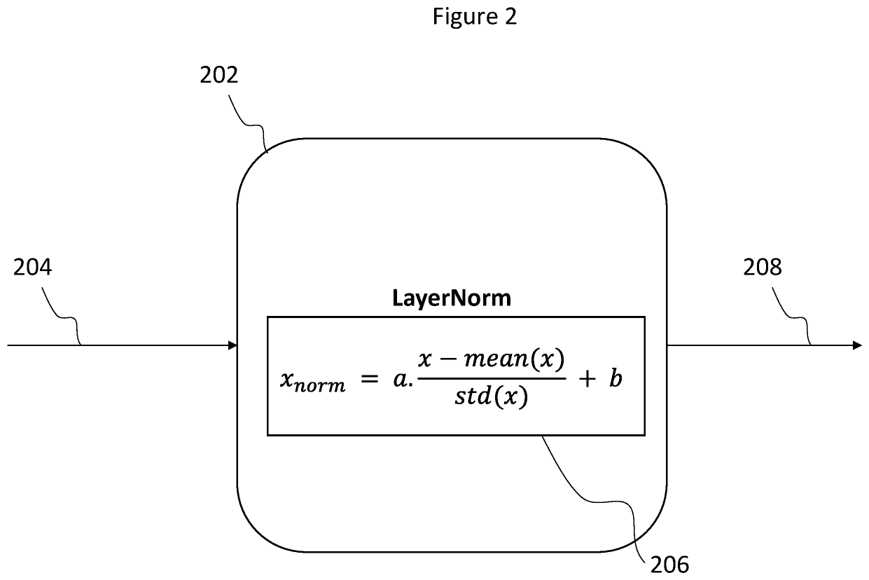

FIG. 2 shows an example normalizer block 202 which performs a LayerNorm normalisation on the matrix input 204 from a previous processing block. A LayerNorm normalizer comprises three operations applied to an input signal matrix X. The operations 206 are performed on the matrix input 204. The mean, mean(x), and standard deviation, std(x), of the x values in a row of the matrix X are computed, and the normalised x values are given by

$$a . \frac{x - mean ( x )}{std ( x )} b , \qquad ( 1 )$$

where a and b are a scale factor and a normalisation bias respectively. The LayerNorm operations are shown in Algorithm 2 below.

Algorithm 2: LayerNorm

```
Inputs: signal matrix X, scale factor a, bias b.
  For x in rows(X):
    x = x − mean(x)
    x = x / std(x)
    x = a * x + b
  return X
```

The neural network computes predictions by sequentially processing a signal through blocks and normalization operations. This is shown in Algorithm 2 below. The number of the block is denoted by n, and the n^{th} block is denoted by blockₙ. The number of the normalisation operation is also denoted by n, and the n^{th} normalisation operation is denoted by normalizerₙ.

Algorithm 3: Computation of neural network

```
Inputs: Blocks 1..n, each containing weight matrices W₁ and W₂ and
non-linearities, Normalization operations 1 ... n, signal matrices X
  Code:
    For n in range (len(blocks)):
      X = X + blockₙ(normalizer_{n·} (X))
Output: processed signals X
```

The form of neural network considered in the present examples encompasses a variety of neural network architectures, including transformer architectures. For example, blocks may alternate between Attention and MLP (multi-layer perceptron) structures, with LayerNorm normalizers between.

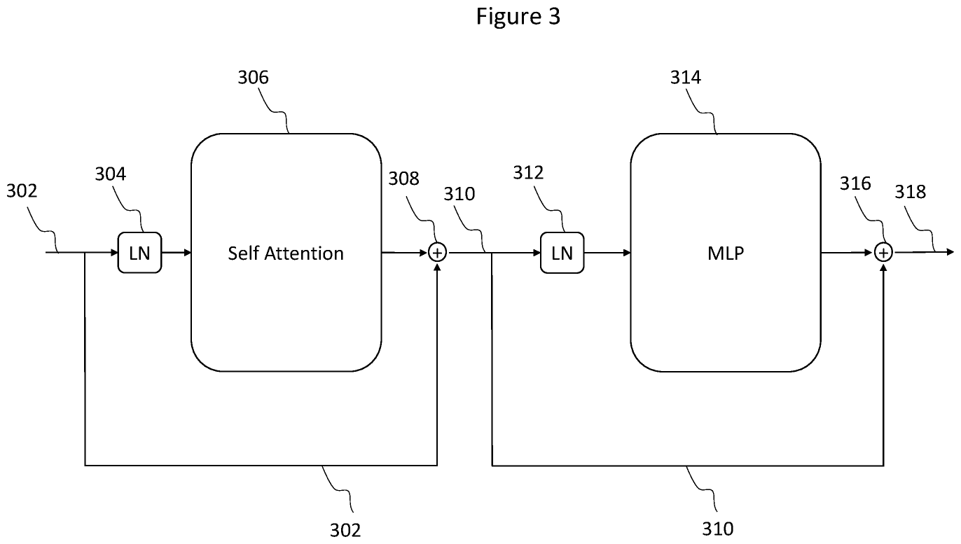

FIG. 3 shows an example architecture with the self-attention structure 306 and the MLP structure 314, with the LayerNorm normalizers 304 and 312 in between. An input signal 302 is received and is processed by the LayerNorm normalizer 304 and the self-attention block structure 306. At step 308, the operation X+blockₙ (normalizerₙ. (X)) from Algorithm 2 is performed to obtain the processed signal 310. The processed signal 310 is further processed by the LayerNorm normalizer 312 and the MLP block structure 314. At step 316, the operation X+blockₙ (normalizerₙ. (X)) from Algorithm 2 is performed to obtain the processed signal 318. Note that a neural network as described herein may be used as a subroutine inside a larger network, such as encoder-decoder architectures and/or with a language-modelling or other application-specific head.

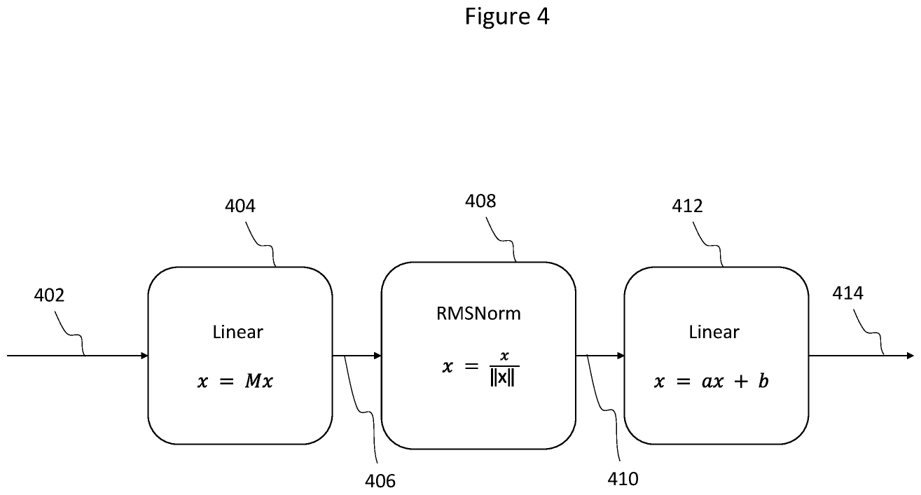

The normalizer operation may be one of LayerNorm, RMSNorm, LINorm or other. FIG. 4 shows an example neural network where the RMSNorm is used for normalisation operations in conjunction with linear layers. The input signal 402 is fed to the linear layer 404, which performs the operation x=Mx on every element x of the input matrix 402. The output 406 of the linear layer 404 is fed to the normalizer block 408. The normalizer block 408 employs an RMSNorm operation, whereby every element of the input matrix 406 is divided by ∥x∥. The output 410 from the normalizer block 408 is fed to the linear layer 412 which performs the linear operation x=ax+b on every element of the input matrix 410, where a is a scaling and b is an offset, giving output 414.

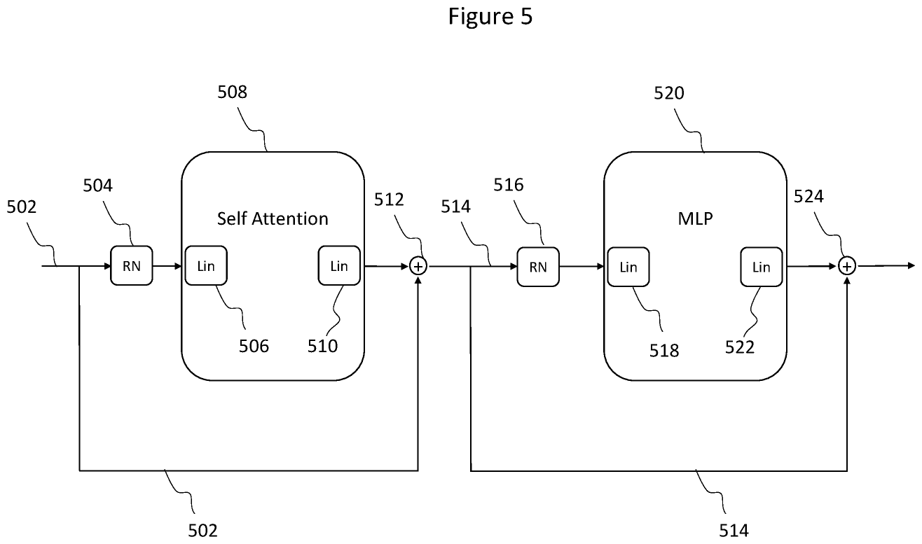

FIG. 5 shows how RMSNorm normalizer blocks may alternate between Attention and MLP (multi-layer perceptron) structures. The input signal 502 is fed to the RMSNorm normalizer block 504. The output of the normalizer block 504 is fed to the first linear layer 506 of the self-attention block 508. In step 512, the operation the operation X+blockₙ (normalizerₙ. (X)) from Algorithm 2 is performed on the original signal 502 and the block-normalised signal from the last layer 510 of the self-attention structure 508. The output of step 512 is the matrix 514 which is fed to the RMSNorm normalizer block 516. The output of the normalizer block 516 is fed to the first linear layer 518 of the MLP block 520. In step 524, the operation the operation X+blockₙ (normalizerₙ. (X)) from Algorithm 2 is performed on the signal 514 and the further block-normalised signal from the last layer 522 of the MLP structure 520.

### Standard Form

Before manipulating a neural network, the normalization operations may be configured into a standard form. This form does not modify the computational complexity of the Algorithm 3, nor does it modify the neural network output. Its purpose is to enable the rotation of weight matrices as will be described below. A StandardNorm block, as shown in in Algorithm 4, consists of a single operation on every row of the signal matrix X:

$$\frac{x}{sqrt \{ sum [ square ( x ) ] \}} \qquad ( 2 )$$

```
Algorithm 4: StandardNorm
Input: signal matrix, X
  For x in rows(X):
    $x = \frac{x}{sqrt \{ sum [ square ( x ) ] \}}$
  return X
```

To convert a Neural network with LayerNorms into standard form, the previous and subsequent linear operations to each LayerNorm are modified.

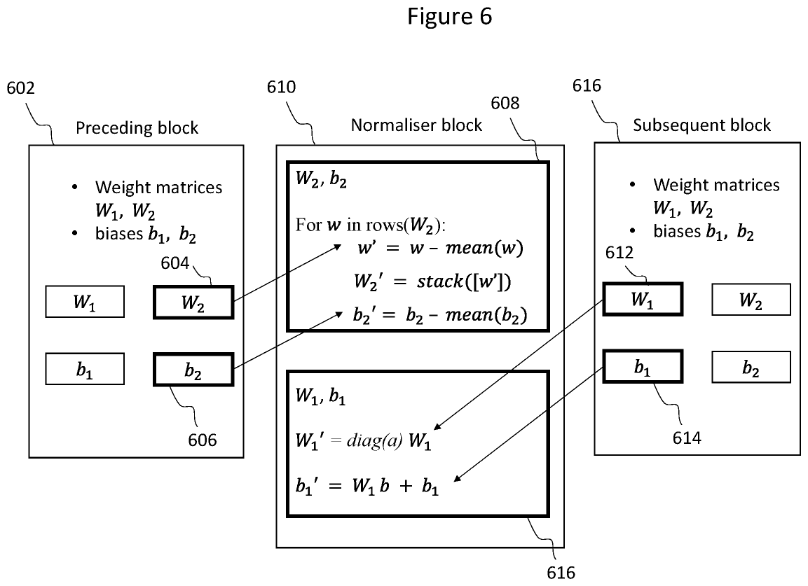

FIG. 6 shows a re-ordering of operations used to a Neural network with LayerNorms into standard form. In step 608, performed at the normaliser block 610, the mean-subtraction is absorbed into the second weight matrix 604, W₂, and the first bias 606, b₂, from the preceding block 602. The rescaling is applied at step 616 using the first weight matrix 612, W₁, and the first bias 614, b₁, the subsequent block 616. These operations are shown in Algorithm 5, where the stack operation joins the rows w′ along the column axis, the diag(a) operation computes the diagonal of scale matrix a.

Algorithm 5: Convert LayerNorm to StandardNorm

```
Inputs: preceding block with weight matrix W₂ and bias b₂; subsequent
block with weight matrix W₁ and bias b₁, LayerNorm normalizer with
scale a, and bias b
  (preceding block)
  For w in rows(W₂):
    w′ = w − mean(w)
    W₂′ = stack([w′])
    b₂′ = b₂ − mean(b₂)
  (subsequent block)
    W₁′ = diag(a) W₁
    b₁′ = W₁ b + b₁
Outputs: modified preceding and subsequent blocks, with matrices W₂′,
W₁′ and biases b₂′, b₁′ respectively.
```

Once each pair of blocks has been updated, the network can be reproduced by replacing each block with the modified block and replacing each instance of LayerNorm with StandardNorm. This has no effect on the output of the neural network, and negligible effect on the computations required. Note that neural networks using RMS norm can be converted similarly.

### Rotation of Weight Matrices

Now that the network is in standard form, a slicing procedure may be applied. First, a calibration dataset is selected, which is used to compute some orthogonal matrices which are then used to modify the neural network. The calibration set can be representative of the task for which the network is designed. For example, in this work, a dataset for sparsity and quantisation work has been used.

Algorithm 6 shows the procedure for rotating the weight matrices of the processing blocks. The rows in the input signal matrix X, to the neural network associated with the calibration dataset are denoted Xₙ, where n=1 . . . N. As shorthand, the notation X={Xₙ} may be used. The orthogonal matrices desired at each of the normalisation blocks are computed. In Algorithm 6, the stack_row operation is used to join the rows in the input matrix X in the column direction to give the matrix Y. The transpose of matrix Y is denoted by YT. The eigenvectors operation is used to find the eigenvectors of a matrix, and the matmul operation denotes matrix multiplication. The set of processing blocks of the neural network is denoted by blocks. The number of the block is denoted by l, and the l^{th} block is denoted by blockₗ. The output of the algorithm is a set of orthogonal matrices {Qₗ}, l=1 . . . . L, where each Qₗ is associated with a standard normalisation block.

Algorithm 6: Compute orthogonal matrices.

```
Inputs: blocks of the neural network, converted to standard form as in
Algorithm 5, input signal matrix X = {Xₙ}
  Y = stack_rows({X})
  Q₀ = eigenvectors(matmul(Y^{T}, Y))
    For blockₗ in blocks:
      For Xₙ in {X}:
        Xₙ = StandardNorm(blockₗ₋₁ (Xₙ) + Xₙ)
      Y = stack_rows({X})
      Qₗ = eigenvectors(matmul(Y^{T}, Y))
Outputs: an orthogonal matrix associated with each standard normalization
block, {Qₗ }, l = 1 ... L
```

### Applying Orthogonal Matrices

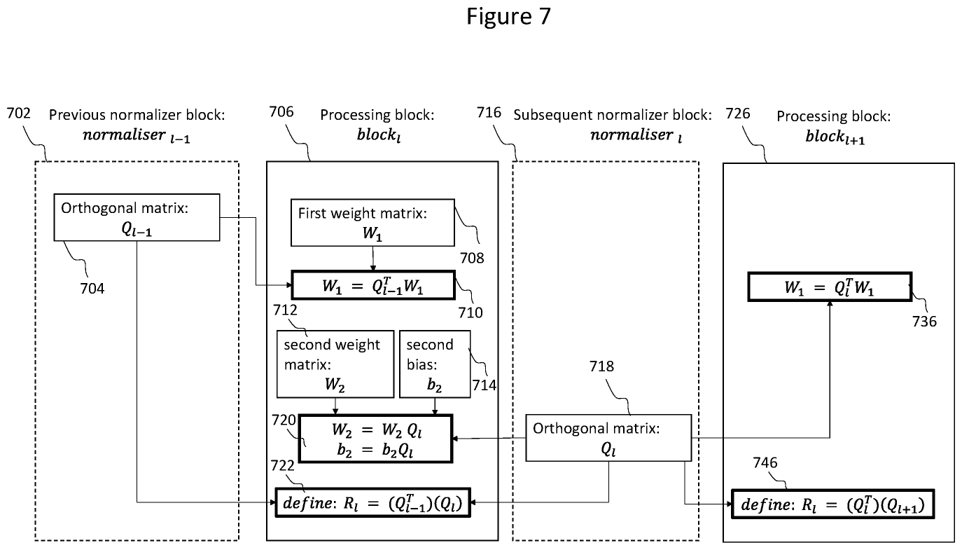

Using the computed set {Qₗ} as in Algorithm 6, each {Qₗ} is then applied to each of the respective blocks in the network. FIG. 7 shows how the orthogonal matrices computed as in Algorithm 6 are applied to a processing block 706 (block 1), preceded by processing block 700 (block 1−1). In step 710, the processing block 706 is modified by multiplying the block's first weight matrix 708, W₁, by the transpose of the orthogonal matrix 704 associated with the previous normalizer 702, Qₗ₋₁^{T}. In step 720, the second matrix 712, W₂, and the second bias b₂, are each multiplied by the orthogonal matrix 718, Qₗ, associated with the subsequent normalizer 716. The orthogonal matrix 718 is then used in subsequent processing block 726 (block 1+1) where the first weight matrix of processing block 726 is modified by multiplication by the transpose of the orthogonal matrix 718. Algorithm 7 shows how the orthogonal matrices computed in Algorithm 6 are applied to the processing blocks in the neural network. Algorithm 7 also defines the matrix Rₗ which will be used in a modified forward pass procedure described further below. In step 722, the matrix Rₗ for the processing block 706 is defined as (Qₗ₋₁^{T})(Qₗ). In step 746, the matrix Rₗ for the processing block 726 is defined as (Qₗ^{T})(Qₗ₊₁).

In Algorithm 6, the input X={Xₙ} to block 0 is the untransformed calibration dataset. The nth output of block 0 is block₀ (Xₙ), which is the n^{th} input to normalizer block 0. At normalized block 0, StandardNorm (block₀ (Xₙ)+Xₙ) is calculated, which becomes the nth input to block 1 (the updated Xₙ), and so on. This input/output relationship is depicted at the bottom of FIG. 6 in respect of blocks 1−1, 1 and 1+1 (700, 706, 726) interleaved with normalizer blocks 1−1 and 1 (702, 716).

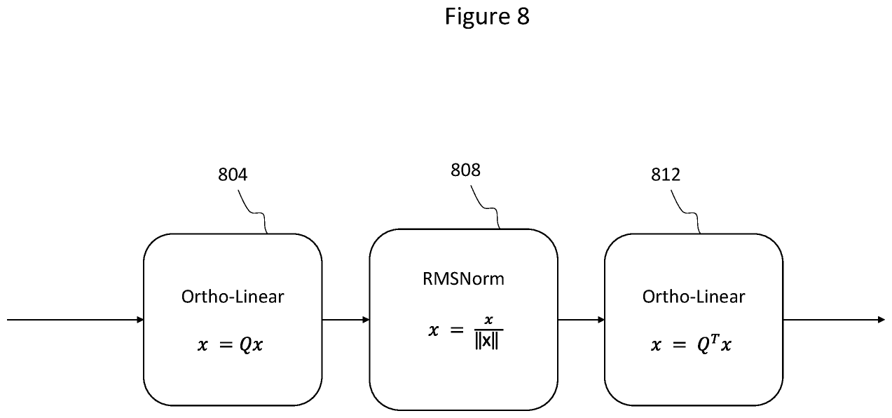

FIG. 8 shows a neural network with alternating linear layers 804, 812 and an RMSNorm normalizer block 808; the matrices used in the linear layers (as in FIG. 4) may be replaced by orthogonal matrices Q and Q^{T} as in Algorithm 7.

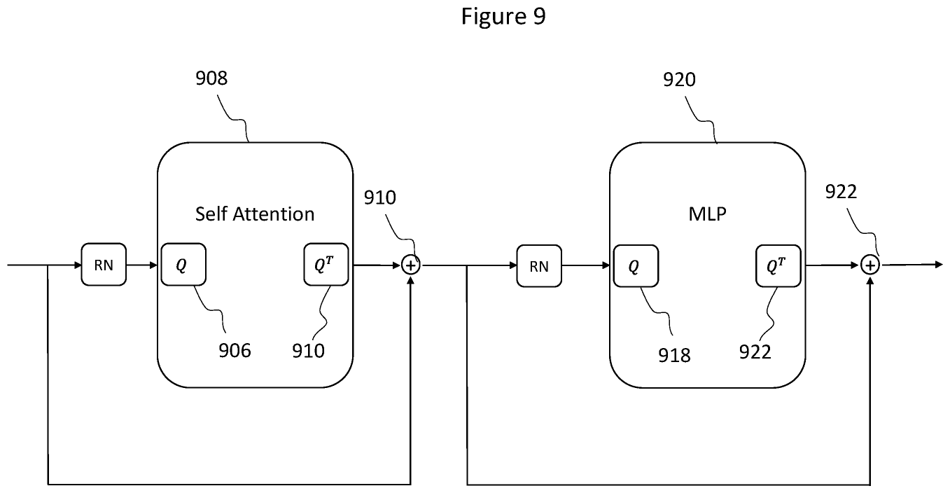

FIG. 9 shows how the neural network in FIG. 5 may be modified by the application of the orthogonal matrices as computed in Algorithm 7. The matrices in the linear layers 506, 510, 518 and 522 are replaced by the orthogonal matrices Q and Q^{T} as in Algorithm 7, to give the ortho-linear layers 906, 910, 918 and 922. The original linear operation Wx is now changed to WQ^{T} Qx by introduction of the orthogonal matrices Q and Q^{T}.

Algorithm 7: Applying orthogonal matrices

```
Inputs: blocks of the neural network, converted to standard form as in
Algorithm 5, set of orthogonal matrices associated with each standard
normalization block, {Qₗ}, l = 1 ... L as obtained in Algorithm 6, bias b₂
    For blockₗ in blocks:
  W₁ = Qₗ₋₁^{T}W₁
  W₂ = W₂ Qₗ
  b₂ = b₂Qₗ
    define: Rₗ = (Qₗ₋₁^{T})(Qₗ)
(Note that b₁ is not modified).
```

Algorithm 8 shows the steps in performing a modified forward pass for the neural network. Algorithm 8 computes exactly the same forward pass as the original network, with all computations of Q cancelling out. This is because matmul (Q, Q^{T})=matmul (Q^{T}, Q)=I. The input signals are modified at the start of Algorithm 8 by Q₀; the first block ‘undoes’ this operation, since it has already been pre-multiplied by Q₀^{T} in Algorithm 7. The outputs of the first block are all modified by Qₗ, which are then passed through the standard-normalization into next processing block, which has similarly been modified using Q₁^{T}. Note that the standard normalization does not affect the cancellation of Qₗ with Q₁^{T}. This is because the standard-normalization block does not affect the orientation of the input matrix, in the sense that: ∥x∥=∥Qₗx∥.

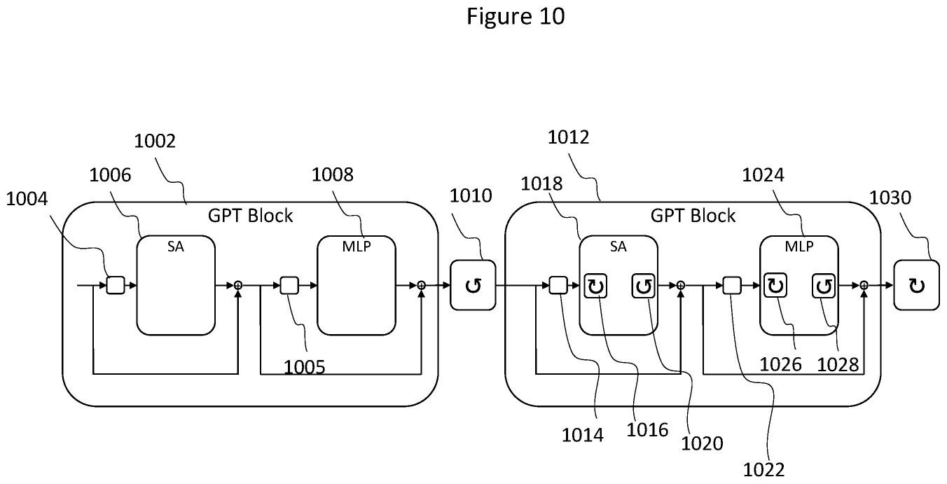

The orthogonal matrices need not be applied at all the blocks of the neural network. FIG. 10 shows a neural network with two generative pre-trained transformer (GPT) blocks 1002 and 1012. The GPT block 1002 consists of the linear layers 1004 and 1005, the self-attention (SA) layer 1006, and the MLP layer 1008. The output of the GPT block 1002 is fed to the linear layer 1010. The output of the linear layer 1010 is fed to the second GPT block 1012. The second GPT block 1012 consists of a linear layer 1014, a SA layer 1018 with linear layers 1016 and 1020, a linear layer 1022, and the MLP layer 1024 with linear layers 1026 and 1028. The output of the GPT block 1030 is fed to the linear layer 1030. As indicated by the arrows, the orthogonal matrices are selectively applied to the linear layers 1010, 1016, 1020, 1026, 1028 and 1030, giving ortho-linear layers.

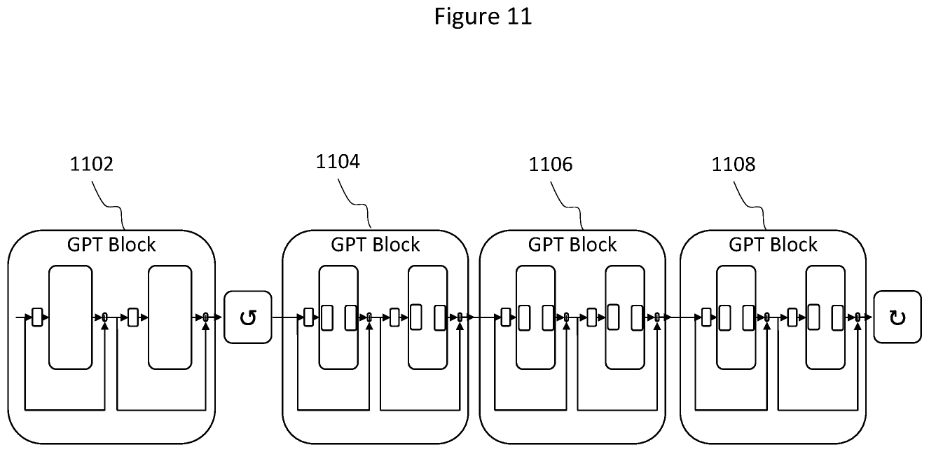

It is also possible to apply the orthogonal matrices to whole blocks or sets of blocks. FIG. 11 shows a neural network with four GPT blocks 1102, 1104, 1106, 1108. The orthogonal matrices are selectively applied to the linear layers in the set of blocks 1104, 1106 and 1108, but not to the linear layers in the GPT block 1102.

Algorithm 8: computation of forward
pass with modified neural network

Inputs: modified neural net blocks, input signal matrix X, the matrix Rₗ
from Algorithm 7 X = matmul(X, Q₀^{T} )
For l in range(len(blocks)):
X = matmul(X, Rₗ) + blockₗ(standard_norm(X))
Outputs: processed signals X

### Slicing

Thus far, a new way to compute the forward pass of a given neural network has been defined, including orthogonal matrices Q that are constructed to project the signal between each block onto its principal components. It is possible to remove those principal components that are small, by slicing off parts of the weight matrix in each block, thus reducing the number of channels required and reducing the overall level of computation. The amount of slicing to apply is controlled by a configurable parameter in one embodiment. Furthermore, since any orthogonal matrix can be freely chosen, it is possible to choose one that projects the inputs onto their largest principal components.

For example, when extracting entities from an average text document data using conventional Large Language models, the required computations take around one minute to complete. This processing time may be reduced by slicing the weight matrices in the neural network used in the Large Language models, thereby reducing computational processing requirements and memory requirements. It is natural to expect that more slicing will result in a worse replication of the original neural network, whilst reducing the compute required for a forward pass. However, experiments show that it is possible to slice off up to around 30% of the lowest relative significance weights in a Large language Model using the present techniques with only small losses in performance (measured in perplexity). In practice, the % of lowest relative that can be removed will depend on a given performance requirement. For example, slicing off more than 30% might be possible in circumstances where a higher loss in performance is acceptable. It will be appreciated that it is not possible to put an absolute limit on the % reduction in all circumstances. However, given a defined performance requirement (such as a maximum permitted drop in performance measured relative to the uncompressed neural network on a predefined performance metric such as perplexity, accuracy, precision, F1 score etc.), it will be possible to determine the number of weights that can be removed through routine experimentation on a modified weight matrix or matrices. The amount of slicing that can be tolerated may vary dependent on the type of model (e.g. text, image, audio, multimodal etc.), which again can be verified through routine experimentation on a modified weight matrix or matrices. ‘Relative significance’ in context refers to significance between different weights of a modified wight matrix assessed in terms of impact on performance or estimated impact on performance. Relative significance may be quantified using a technique such as singular value decomposition (SVD) or principal component analysis (PCA), where it is generally expected that SVD or PCA scores will at least approximately align with performance (in the sense that removing a component with a higher PCA or SVD score will on average have a greater impact on performance than removing a component with a lower PCA or SVD score). Note that removing a component of relatively low significance does not necessarily imply a ‘thresholding’ approach (such as removing a fixed % or number of weights with lowest significance scores). For example, in another embodiment, a probabilistic approach could be used to remove weights with probabilities determined by their significance scores (so that lower scoring weights are more likely to be removed). Algorithm 9 shows the steps followed in slicing the weight matrices of a neural network. The original channel width is denoted by C the new desired channel width is C′. In Algorithm 9, the [ ] brackets are used to denote the selection of elements from a matrix. For example, the operation Q₀[:,: C′] selects all the rows in matrix Q₀ but only the first C′ columns in matrix Q₀. The operation W₁ [: C′,:] selects the first C′ rows in matrix W₁, and all the columns in matrix W₁. The operation W₂ [:,: C′] selects all the rows in matrix W₂ and the first C′ columns in matrix W₂. The operation b₂=b₂ [: C′] selects the first C′ rows in bias b₂. The operation Rₗ[: C′,: C′] selects the first C′ rows and the first C′ columsn in the matrix Rₗ.

Algorithm 9: Slicing the weight matrices

```
Input: new channel width C′ , set of processing blocks of neural network
Q₀= Q₀[:, : C′]
  For blockₗ in blocks:
    W₁ = W₁[: C′, :]
    W₂ = W₂[:, : C′]
    b₂ = b₂ [: C′]
    Rₗ = Rₗ [: C′, : C′]
(Note that b₁ is unmodified).
```

To compute the forward pass of the sliced neural network, Algorithm 8 is applied. Note that each matrix multiplication is reduced by a factor of C′/C. This increases efficiency, and reduces processing. This also reduces amount of memory required to store the neural network.

It is also possible to reduce the number of neurons in a MLP layer by projecting the weight matrices onto the nearest set of orthogonal polynomials. This can be done in addition to the slicing described above, achieving a quadratic speedup in one of the main computations in the SA layer.

The projection of the signal between each block onto its principal components can be done by a singular value decomposition (SVD). Because the angle of reconstruction is the ‘sufficient statistic’ of the error, L1-norm SVD works better than a naïve SVD. This is approximately a spherical reduction algorithm (in the small error regime where sin (x)=x). Inside the MLP, the angle of the orthogonal matrix to the weight vector is all that is required. Thus, it is favourable to choose a rotation Q that makes the data orthogonal to the ‘north pole’, and delete the last element: z=DQx.

The ML architecture described herein, and the neural network compression mechanism in particular, has many practical applications in various fields of technology. In broad terms, the neural network could for example be configured as a declarative network, used for, say, classification or regression tasks (a declarative network, broadly speaking, learns to generate predictions on previously unseen data) or a generative network (which, broadly speaking, has the ability to generate new datapoints). Applications of the neural network include image classification or extracting information from images (e.g. classifying images, image regions, or image pixels; locating objects in images, e.g. by predicting object bounding boxes etc.), text classification, the extraction of structured or semi-structured information from text, audio signal classification (e.g. classifying different parts of an audio signal, e.g. in the context of voice recognition, to separate speech from non-speech, or to convert speech to text), extracting information from sensor signals, e.g. performing measurements using a classification or regression network operating on signals from one or more sensors, for example in a machine control application (e.g. such measurements may be used to measure physical characteristics of or relevant to a machine or system such as a vehicle, robot, manufacturing system, energy production system etc.), or in a medical sensing application such as patient monitoring or diagnostics (e.g. to monitor and classify a patient's vitals). Other applications include generating images (e.g. based on a text or non-text input), text (e.g. translating text from one language to another, or generating a response to a user's text input), audio data (e.g. synthetic speech, music or other sounds) or music (e.g. in digital or symbolic music notation), computer code that may be executed on a processor (e.g. computer code to control or implement a technical process on a computer or machine, e.g. generating code in response to a user's instructions express in natural language, translating or compiling code, such as source code, object code or machine code, from one programming language to another), modeling or simulation of physical, chemical and other technical systems, or discovering new chemical components or new uses thereof (including ‘drug discovery’ applications, to discover new therapeutic compounds or medicines, or new therapeutic uses). Any of the aforementioned applications, among others, may be improved in terms of performance (e.g., accuracy, precision, robustness/reliability) when using the neural network compression method (which, as noted, may be learned and shared across multiple applications/modalities). Further, less memory and/or processing resources are required when performing any of the aforementioned applications by using the neural network compression method. The system also has applications in cybersecurity. For example, a cybersecurity-specific knowledge base may be constructed using the described methods, to support a neural network carrying out a cybersecurity function, such as identifying anomalous or potentially suspicious data points or signals in cybersecurity data (which may, for example, embody cybersecurity telemetry collected using endpoint software and/or network monitoring component(s) etc.), or patterns indicative of potentially suspicious activity or behavior, so that an appropriate reporting, remediation or other cybersecurity action may be taken (e.g. generating an alert, terminating or quarantining an application, service or process, revoking user or application privileges etc.) based on an output of the neural network supported by the knowledge base (e.g. a detection output indicating potentially suspicious activity/behavior that has been detected, or another form of cybersecurity detection outcome). A generative cybersecurity model supported by a knowledge base may, for example, be configured to generate ‘synthetic’ cybersecurity data e.g., for the purpose of training, testing or validating other cybersecurity component(s) and model(s).

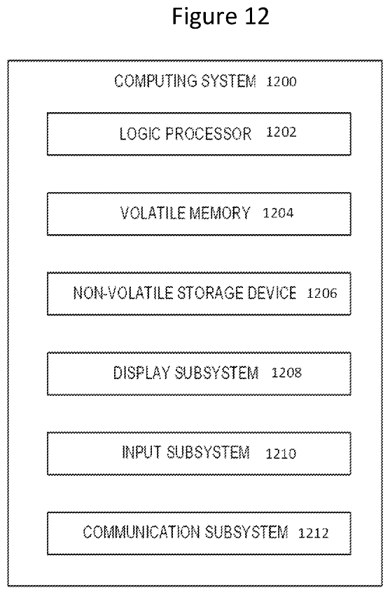

FIG. 12 schematically shows a non-limiting example of a computing system 1200, such as a computing device or system of connected computing devices, that can enact one or more of the methods or processes described above, including the filtering of data and implementation of the structured knowledge base described above. Computing system 1200 is shown in simplified form. Computing system 1200 includes a logic processor 1202, volatile memory 1204, and a non-volatile storage device 1206. Computing system 1200 may optionally include a display subsystem 1208, input subsystem 1210, communication subsystem 1212, and/or other components not shown in FIG. 12. Logic processor 1202 comprises one or more physical (hardware) processors configured to carry out processing operations. For example, the logic processor 1202 may be configured to execute instructions that are part of one or more applications, programs, routines, libraries, objects, components, data structures, or other logical constructs. The logic processor 1202 may include one or more hardware processors configured to execute software instructions based on an instruction set architecture, such as a central processing unit (CPU), graphical processing unit (GPU) or other form of accelerator processor. Additionally or alternatively, the logic processor 1202 may include a hardware processor(s)) in the form of a logic circuit or firmware device configured to execute hardware-implemented logic (programmable or non-programmable) or firmware instructions. Processor(s) of the logic processor 1202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 1202 may be virtualized and executed by remotely accessible, networked computing devices configured in a cloud-computing configuration. In such a case, these virtualized aspects are run on different physical logic processors of various different machines. Non-volatile storage device 1206 includes one or more physical devices configured to hold instructions executable by the logic processor 1202 to implement the methods and processes described herein. When such methods and processes are implemented, the state of non-volatile storage device 1206 may be transformed—e.g., to hold different data. Non-volatile storage device 1206 may include physical devices that are removable and/or built-in. Non-volatile storage device 1206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive), or other mass storage device technology. Non-volatile storage device 1206 may include nonvolatile, dynamic, static, read/write, read-only, sequential-access, location-addressable, file-addressable, and/or content-addressable devices. Volatile memory 1204 may include one or more physical devices that include random access memory. Volatile memory 1204 is typically utilized by logic processor 1202 to temporarily store information during processing of software instructions. Aspects of logic processor 1202, volatile memory 1204, and non-volatile storage device 1206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example. The terms “module,” “program,” and “engine” may be used to describe an aspect of computing system 1200 typically implemented in software by a processor to perform a particular function using portions of volatile memory, which function involves transformative processing that specially configures the processor to perform the function. Thus, a module, program, or engine may be instantiated via logic processor 1202 executing instructions held by non-volatile storage device 1206, using portions of volatile memory 1204. Different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc. When included, display subsystem 1208 may be used to present a visual representation of data held by non-volatile storage device 1206. The visual representation may take the form of a graphical user interface (GUI). As the herein-described methods and processes change the data held by the non-volatile storage device, and thus transform the state of the non-volatile storage device, the state of display subsystem 1208 may likewise be transformed to visually represent changes in the underlying data. Display subsystem 1208 may include one or more display devices utilizing virtually any type of technology. Such display devices may be combined with logic processor 1202, volatile memory 1204, and/or non-volatile storage device 1206 in a shared enclosure, or such display devices may be peripheral display devices. When included, input subsystem 1210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 1212 may be configured to communicatively couple various computing devices described herein with each other, and with other devices. Communication subsystem 1212 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1200 to send and/or receive messages to and/or from other devices via a network such as the internet. The term computer readable media as used herein may include computer storage media. Computer storage media may include volatile and non-volatile, removable and nonremovable media (e.g., volatile memory 1204 or non-volatile storage 1206) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g. the computing system 1200 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a computer-implemented method, comprising: determining an orthogonal matrix using a neural network applied to a calibration dataset, the neural network comprising: a first processing block and a normalizer block having an input connected to an output of the first processing block, multiplying a first weight matrix of the first processing block by the orthogonal matrix, resulting in: a modified first weight matrix comprising multiple components ordered by relative significance; removing at least one component of relatively low significance from the modified first weight matrix, resulting in a truncated first weight matrix; generating in computer-storage, based on the neural network, a compressed neural network comprising a compressed first processing block, the compressed first processing block configured to apply the truncated first weight matrix to an input received at the compressed first processing block.

In embodiments, the neural network may comprise a second processing block having an input connected to an output of the normalizer block, the method comprising: multiplying a second weight matrix of the second processing block by a transpose of the orthogonal matrix, resulting in: a modified second weight matrix comprising multiple components ordered by relative significance; removing at least one component of relatively low significance from the modified second weight matrix, resulting in a truncated second weight matrix; generating in computer-storage, based on the neural network, a compressed neural network comprising a compressed second processing block, the compressed second processing block configured to apply the truncated second weight matrix to an input received at the compressed second processing block.

In the example embodiments described above, the first processing block may correspond to block 706 in FIG. 7 (block 1) and the second processing block may correspond to block 726 (1+1). In this example, the first weight matrix corresponds to the W₂ weight matrix in block 1 and the second weight matrix corresponds to the W₁ weight matrix in block 1+1, with the orthogonal matrix correspond to Qₗ.

The method may comprise determining the second weight matrix of the second block by performing a scaling operation on a third weight matrix.

The method may comprise: generating an input to the first processing block using a third processing block of the neural network preceding the first processing block and a second normalizer block of the neural network connected between the third processing block and the first processing block; and determining based on the input a calibration result matrix, wherein the orthogonal matrix may be computed from eigenvectors of the calibration result matrix multiplied by a transpose of the calibration result matrix.

In the example of FIG. 7, the third processing block may correspond to processing block 700(1-1) and the second normalizer block may correspond to normalizer block 702(1-1).

The method may comprise: determining the first weight matrix of the first block by performing a subtraction operation based on a fourth weight matrix and the mean value at the output of the normalizer when the neural network comprises the third weight matrix.

The method may comprise: providing an input into the compressed first processing block.

The normalizer block may perform a StandardNorm function.

The method may comprise: generating an output using the compressed neural network applied to an input comprising at least one of: image data, video data, audio data, text data, cybersecurity data, sensor data, medical data.

The input may be measured by a sensor.

The output may cause a physical device to perform an action based on the output.

The method may comprise: generating an output using the compressed neural network applied to an input, the output comprising at least one of: image data, video data, audio data, text data, cybersecurity data, sensor data, medical data.

A second aspect herein provides a computer system comprising: at least one processor coupled to the at least one memory, and configured to execute the executable instructions, which upon execution cause the at least one processor to at least one processor coupled to the at least one memory, and configured to execute the executable instructions, which upon execution cause the at least one processor to: determine an orthogonal matrix using a neural network applied to a calibration dataset, the neural network comprising: a first processing block and a normalizer block having an input connected to an output of the first processing block, multiply a first weight matrix of the first processing block by the orthogonal matrix, resulting in: a modified first weight matrix comprising multiple components ordered by relative significance; remove at least one component of relatively low significance from the modified first weight matrix, resulting in a truncated first weight matrix; generate in computer-storage, based on the neural network, a compressed neural network comprising a compressed first processing block, the compressed first processing block configured to apply the truncated first weight matrix to an input received at the compressed first processing block.

In embodiments, the neural network may comprise a second processing block having an input connected to an output of the normalizer block, and the at least one processor may be configured to: multiply a second weight matrix of the second processing block by a transpose of the orthogonal matrix, resulting in: a modified second weight matrix comprising multiple components ordered by relative significance; remove at least one component of relatively low significance from the modified second weight matrix, resulting in a truncated second weight matrix; generate in computer-storage, based on the neural network, a compressed neural network comprising a compressed second processing block, the compressed second processing block configured to apply the truncated second weight matrix to an input received at the compressed second processing block.

The at least one processor configured to: determining the second weight matrix of the second block by performing a scaling operation on a third weight matrix.

The at least one processor may be configured to: determine the first weight matrix of the first block by performing a subtraction operation based on a fourth weight matrix and the mean value at the output of the normalizer when the neural network comprises the third weight matrix.

The at least one processor may be configured to: provide an input into the compressed first processing block.

The normalizer block may perform a StandardNorm function.

The at least one processor may be configured to: generate an output using the compressed neural network applied to an input comprising at least one of: image data, video data, audio data, text data, cybersecurity data, sensor data, medical data.

The output may cause a physical device to perform an action based on the output.

A third aspect herein provides a computer-readable storage media storing computer-readable instructions configured, when executed by at least one processor, to: receive an input; process the input using a compressed neural network, the compressed neural network comprising a truncated first weight matrix obtained by: determining an orthogonal matrix using a neural network applied to a calibration dataset, the neural network comprising: a first processing block and a normalizer block having an input connected to an output of the first processing block, multiplying a first weight matrix of the first processing block by the orthogonal matrix, resulting in: a modified first weight matrix comprising multiple components ordered by relative significance; removing at least one component of relatively low significance from the modified first weight matrix, resulting in the truncated first weight matrix.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claims.

The invention claimed is:

1. A computer-implemented method, comprising:
determining an orthogonal matrix using a neural network applied to a calibration dataset, the neural network comprising: a first processing block and a normalizer block having an input connected to an output of the first processing block,
multiplying a first weight matrix of the first processing block by the orthogonal matrix, resulting in: a modified first weight matrix comprising multiple components ordered by relative significance;
removing at least one component of relatively low significance from the modified first weight matrix, resulting in a truncated first weight matrix;
generating in computer-storage, based on the neural network, a compressed neural network comprising a compressed first processing block, the compressed first processing block configured to apply the truncated first weight matrix to an input received at the compressed first processing block.

2. The computer-implemented method of claim 1, wherein the neural network comprises a second processing block having an input connected to an output of the normalizer block, the method comprising:
multiplying a second weight matrix of the second processing block by a transpose of the orthogonal matrix, resulting in: a modified second weight matrix comprising multiple components ordered by relative significance;
removing at least one component of relatively low significance from the modified second weight matrix, resulting in a truncated second weight matrix;
generating in computer-storage, based on the neural network, a compressed neural network comprising a compressed second processing block, the compressed second processing block configured to apply the truncated second weight matrix to an input received at the compressed second processing block.

3. The computer-implemented method of claim 2, the method comprising:
determining the second weight matrix of the second block by performing a scaling operation on a third weight matrix.

4. The computer-implemented method of claim 2, comprising:
generating an input to the first processing block using a third processing block of the neural network preceding the first processing block and a second normalizer block of the neural network connected between the third processing block and the first processing block; and
determining based on the input a calibration result matrix, wherein the orthogonal matrix is computed from eigenvectors of the calibration result matrix multiplied by a transpose of the calibration result matrix.

5. The computer-implemented method of claim 1, the method comprising:
determining the first weight matrix of the first block by performing a subtraction operation based on a fourth weight matrix and the mean value at the output of the normalizer when the neural network comprises the third weight matrix.

6. The computer-implemented method of claim 1, the method comprising:
providing an input into the compressed first processing block.

7. The computer-implemented method of claim 1, wherein the normalizer block performs a StandardNorm function.

8. The computer-implemented method of claim 1, the method comprising:
generating an output using the compressed neural network applied to an input comprising at least one of: image data, video data, audio data, text data, cybersecurity data, sensor data, medical data.

9. The computer-implemented method of claim 8, wherein the input is measured by a sensor.

10. The computer-implemented method according to claim 8, wherein the output causes a physical device to perform an action based on the output.

11. The computer-implemented method of claim 1, the method comprising:
generating an output using the compressed neural network applied to an input, the output comprising at least one of: image data, video data, audio data, text data, cybersecurity data, sensor data, medical data.

12. A computer system comprising:
at least one memory configured to store executable instructions; and
at least one processor coupled to the at least one memory, and configured to execute the executable instructions, which upon execution cause the at least one processor to:
determine an orthogonal matrix using a neural network applied to a calibration dataset, the neural network comprising: a first processing block and a normalizer block having an input connected to an output of the first processing block,
multiply a first weight matrix of the first processing block by the orthogonal matrix, resulting in: a modified first weight matrix comprising multiple components ordered by relative significance;
remove at least one component of relatively low significance from the modified first weight matrix, resulting in a truncated first weight matrix;
generate in computer-storage, based on the neural network, a compressed neural network comprising a compressed first processing block, the compressed first processing block configured to apply the truncated first weight matrix to an input received at the compressed first processing block.

13. The computer system of claim 12, wherein the neural network comprises a second processing block having an input connected to an output of the normalizer block, the at least one processor configured to:
multiply a second weight matrix of the second processing block by a transpose of the orthogonal matrix, resulting in: a modified second weight matrix comprising multiple components ordered by relative significance;
remove at least one component of relatively low significance from the modified second weight matrix, resulting in a truncated second weight matrix;
generate in computer-storage, based on the neural network, a compressed neural network comprising a compressed second processing block, the compressed second processing block configured to apply the truncated second weight matrix to an input received at the compressed second processing block.

14. The computer system of claim 13, the at least one processor configured to:
determine the second weight matrix of the second block by performing a scaling operation on a third weight matrix.

15. The computer system of claim 12, the at least one processor configured to:
determine the first weight matrix of the first block by performing a subtraction operation based on a fourth weight matrix and the mean value at the output of the normalizer when the neural network comprises the third weight matrix.

16. The computer system of claim 12, the at least one processor configured to:
provide an input into the compressed first processing block.

17. The computer system of claim 12, wherein the normalizer block performs a StandardNorm function.

18. The computer system of claim 12, the at least one processor configured to: generate an output using the compressed neural network applied to an input comprising at least one of: image data, video data, audio data, text data, cybersecurity data, sensor data, medical data.

19. The computer system according to claim 18, wherein the output causes a physical device to perform an action based on the output.

20. Computer-readable storage media storing computer-readable instructions configured, when executed by at least one processor, to:
receive an input;
process the input using a compressed neural network, the compressed neural network comprising a truncated first weight matrix obtained by:
determining an orthogonal matrix using a neural network applied to a calibration dataset, the neural network comprising: a first processing block and a normalizer block having an input connected to an output of the first processing block,
multiplying a first weight matrix of the first processing block by the orthogonal matrix, resulting in: a modified first weight matrix comprising multiple components ordered by relative significance;
removing at least one component of relatively low significance from the modified first weight matrix, resulting in the truncated first weight matrix.
